(19) United States
(12) Patent Application Publication
(10) Pub. No.: US 2012/0043391 A1
(43) Pub. Date: Feb. 23, 2012

(54) SPRAY DEVICE

(75) Inventors: Mark Robson Humphries, Essex (GB); Craig Harvey Nelson, Herts (GB); Stuart Michael Ruan Jones, Royston (GB); David Richard Stonehouse, Cambridge (GB); Edwin Paul Earnshaw, Herts (GB); Andrew Macleod, Cambridge (GB)

(73) Assignee: PA KNOWLEDGE LIMITED

(21) Appl. No.: 13/211,980

(22) Filed: Aug. 17, 2011

(30) Foreign Application Priority Data
Aug. 18, 2010 (GB) GB 1013849.3

(51) Int. Cl. B05B 9/03

(52) U.S. Cl. 239/1; 239/302

(57) ABSTRACT

A spray device for connection to a reservoir of fluid for spraying, the spray device includes a dosing chamber for holding fluid; a connector for fluidly connecting the dosing chamber to the reservoir; a piston moveable from a first end of the dosing chamber to a second end of the dosing chamber so as to draw into the dosing chamber fluid from the reservoir; a spring biasing the piston towards said first end; a plunger, actuable by a user, to move the piston towards said second end against the bias of the spring; a nozzle for spraying fluid; and a user-actuable valve for selectively fluidly connecting the dosing chamber to the nozzle.

### CROSS-REFERENCE TO RELATED APPLICATIONS

This application is based upon and claims the benefit of priority from British Application No. 1013849.3 filed 18 Aug. 2010, the entire contents of which are incorporated by reference.

### BACKGROUND OF THE INVENTION

1. Field of the Invention

The present invention relates to a method of preparing a liquid for spraying, a spray device using that method and assemblies using the spray device with one or more reservoirs of liquid for spraying.

2. Description of the Related Art

Previously, various systems have been devised for spraying liquid, for instance as an aerosol. These include finger and trigger pumps, liquid propellant aerosols and compressed gas aerosols.

The assemblies for finger pumps and trigger pumps include a number of components (normally between 7 and 12); including one-way valves, intermediate fluid holding chambers, springs seals and a fluid connection means to a reservoir containing the liquid to be sprayed.

During initial actuation through the application of a force to the trigger or button, the volume within the holding chamber is reduced. This volume reduction drives out residual air from the holding chamber.

As the button or trigger is released mechanical forces within the sub assembly (e.g. metal or plastic springs) act to increase the volume within the holding chamber. This volume increase reduces the pressure within the holding chamber, opening the valve connecting the holding chamber to the liquid reservoir. Due to the pressure differential between the reservoir and the holding chamber, liquid is sucked into the holding chamber, where it remains in a non-pressurised state until the next actuation stroke.

During subsequent actuations, a pressure increase occurs within the holding chamber as its volume is reduced, forcing the liquid from the holding chamber through an exit orifice/nozzle.

### OBJECTS AND SUMMARY OF THE INVENTION

These arrangements have a number of disadvantages. They are relatively complex systems. They are only capable of dispensing pre-set discrete volumes, in other words digital delivery volumes. The delivery volumes tend to be small per actuation (for instance up to 30 millilitres, but generally up to 1.3 millilitres, per actuation for trigger pumps and several hundred microlitres for finger sprays). The quality of spray varies depending upon user/actuation force. For non-pre-compression systems, dribbling and/or poor liquid breakup and poor cut-off characteristics can and does frequently occur. No spray may occur upon first stroke/strokes until the pump is primed.

Liquefied Propellant aerosols use liquified propellants. Liquefied propellants are gases that exist as liquids under pressure. Because the aerosol is under pressure, the propellant exists mainly as a liquid, but it will at room temperature also be in the head space as a vapour. As the product is used up as the valve is opened, some of the liquid propellant turns to vapour. In this way the pressure in the can remains essentially constant and the spray performance is maintained throughout the life of the aerosol.

The propellant is an essential element in the formulation. When the liquid propellant emerges from the actuator, the droplets vaporise, and if the propellant is intimately mixed with droplets of the product, these will be atomised into smaller droplets.

The ultimate size of the droplets can be controlled by adjusting the type/amount of propellant, and its pressure, in the aerosol.

The design of the actuator is also important, as this will have a significant effect on the droplet size due to the mechanical action on the liquid, as it passes through the small holes and channels within the actuator.

Typical propellants for liquified propellant aerosols are described below.

Liquefied Petroleum Gas (LPG) is the most common

Aerosol propellant grade LPG consists of high purity hydrocarbons. They consist of a mixture of propane, iso-butane and n-butane.

These gases are flammable and incur a range of handling and storage restrictions.

Di Methyl Ether is used

This is an alternative liquefied propellant, and is more common in personal care products, and some air fresheners. Again, it is highly flammable.

Chlorofluorocarbons (CFCs/HFCs) are used

They are used in inhalation aerosols, highly ozone depleting/greenhouse gases.

These systems have various disadvantages. They are flammable, potentially ozone-depleting, are necessarily pressurised systems such that there is a requirement for the pressure vessel. Costs can be high. There may be a requirement for specialist manufacturing equipment and a requirement for special storage precautions.

Compressed gas aerosols are also used

Compressed gas propellants occupy the head space above the liquid in the can. When the aerosol valve is opened, the gas ‘pushes’ the liquid out of the can. The amount of gas in the headspace remains the same but, as the product is expelled, it has more space, and as a result the pressure will drop during the life of the can.

Unlike liquefied propellants, there is no liquid to instantly vaporise when the product emerges from the actuator, and only the product is sprayed out.

The means of creating the droplets required to form an acceptable spray is by breaking up the liquid through mechanical action as it passes through both the valve and the actuator. The choice and geometric design of these components is critical.

Typical propellants for compressed gas aerosols are described below.

Non-soluble compressed Gasses (e.g. Compressed Air and Nitrogen) are used

These are sometimes seen in consumer products, and are an environmental alternative to LPG.

Soluble compressed Gasses (e.g. Carbon Dioxide) are used

This is another alternative to LPG, but has limited use, mainly with alcoholic systems, such as air treatment products, deodorants and personal care products.

These systems also have their own disadvantages. They are pressurised and have a requirement for a pressure vessel. Also, the pressure will vary throughout the life of the product adversely affecting spray consistency and performance may vary depending upon spray orientation. They can be relatively costly and there may be a requirement for specialist manufacturing equipment.

Other common aerosol/spray systems include bag in can solutions. These can be either compressed gas or liquid propellant driven, and have the product separated from the propellant through the use of an internal collapsible bag which contains the product. Air pump systems are also known. These are systems into which air can be pumped to create an overpressure. They often include a venting valve to depressurise the system for storage and transport. Such systems are commonly used as agricultural sprayers.

According to the present invention, there is provided a spray device for connection to a reservoir of fluid for spraying. The spray device includes a dosing chamber for holding fluid, a connector for fluidly connecting the dosing chamber to the reservoir, a piston moveable from a first end of the dosing chamber to a second end of the dosing chamber so as to draw into the dosing chamber fluid from the reservoir, a spring biasing the piston towards said first end, a plunger, actuable by a user, to move the piston towards said second end against the bias of the spring, a nozzle for spraying fluid, and a user-actuable valve for selectively fluidly connecting the dosing chamber to the nozzle.

There is also provided a method of spraying fluid including using a user-actuable plunger to move a piston in a dosing chamber to draw fluid from a reservoir into the dosing chamber against the bias of a spring acting on the piston and selectively connecting the dosing chamber to a nozzle so as to allow fluid to be expelled from the dosing chamber under the bias of the spring and through the nozzle.

Preferably the arrangement is provided separately from the fluid reservoir and can be freely connected or disconnected from the fluid reservoir independently of whether or not fluid is held in the dosing chamber.

A valve may be provided for connection between the device and the fluid reservoir so as to allow only one-way flow of fluid from the reservoir to the dosing chamber.

The device may be connected to two or more reservoirs such that the piston can be moved so as to draw into the dosing chamber a mixture of fluids from the reservoirs. Appropriate metering between the reservoirs may be provided. This may be advantageous where the mixed product has a limited shelf life.

Alternatively, the plunger (or more than one plunger) can be arranged to move two or more pistons within respective dosing chambers, each dosing chamber being connected to a respective reservoir. The nozzle can be connected to the plurality of dosing chambers so as to mix fluids only at the point of spraying/dispensing.

Assemblies may be provided including both the spray device and one or more reservoirs.

The following provides details of other possibilities for the present invention.

A dosing chamber (or plurality of dosing chambers) having the ability to be pressurised.

A dosing chamber (or plurality of dosing chambers) having the ability to be filled or partially filled from a non-pressurised fluid reservoir (or a plurality of fluid reservoirs) through a valve mechanism.

A process of filling the dosing chamber from the non-pressurised fluid reservoir that is initiated by a pressure drop within the dosing chamber through the use of mechanical, electrical, pneumatic or other actuation method.

A dosing chamber which can be pressurised using one or more of a number of energy storage systems, e.g. springs, elastomeric bags, chemical phase change, etc.

A dosing chamber in which the energy stored can provide the necessary mechanical force or hydraulic or pneumatic pressure to force the fluid from the dosing chamber and through a dispensing orifice/nozzle when the outlet valve is opened.

A fluid delivery volume which can be analogue and or digital.

The spring-based mechanical energy storage system in which the spring characteristics can be selected in conjunction with the outlet orifice/nozzle, the dimensions of the dosing chamber and valve to provide a high-quality spray and minimise dribbling.

A dosing chamber which can be stored in pressurised or non-pressurised state, reducing its requirements as pressure vessel.

A non-pressurised fluid reservoir with a means of venting to avoid the creation of vacuum (i.e. pressure lower than atmospheric) within the reservoir.

A non-pressurised fluid reservoir with a means of collapse in order to avoid the creation of vacuum within the reservoir.

One or more fluid reservoirs supplying a common dosing chamber (preventing product mixing in their normal storage state).

One or more fluid reservoirs and/or one or more secondary pressurised dosing chambers selected to control the ratio of the primary and secondary fluids and designed keep the primary and secondary fluids apart prior to the point of dispense.

A system in which the non-pressurised fluid reservoir could be constructed from a variety of materials and support extensive design flexibility.

Formats could include fixed volume containers, e.g. bottles or cans, etc. flexible containers such as sachets, pouches or collapsible tubes, providing for airless solutions.

A non-pressurised fluid container which could be refillable, or sold as refills that attaches to a reusable pump and dosing chamber mechanism; this would provide opportunities for minimising packaging waste and reducing the cost of goods.

An attachment means between the non-pressurised fluid reservoir and the pump mechanism designed to ensure that it mates only with selected products in order to assure appropriate matching between the source of mechanical energy, the outlet orifice and the fluid to be dispensed can be achieved.

A dosing chamber which, once filled, operates in all orientations with no significant degradation in performance.

A dosing chamber which in conjunction with a collapsible primary container can be refilled and will operate in all orientations without significant degradation in performance.

A fluid reservoir and dosing chambers that can individually or jointly be made from transparent materials enabling fluid levels to be tracked.

An actuation system having the potential to use the action of removing the closure or cap to energise the mechanical energy store within the dosing chamber.

A system having the potential, when the dosing chamber contains fluid, to be used as an aerosol-generating device in conjunction with or in isolation from the non-pressurised fluid reservoir. In the absence of the fluid reservoir a small, light-weight portable pressurised unit is created.

A system which provides the opportunity to have a range of sizes/volumes of primary containers or a selection of primary containers that can be exchanged into/out of the pump and dosing chamber system.

The invention can give rise to the following benefits.

Benefits Vs. Finger and Trigger Pumps

Sustained spray, not limited to small/fixed actuation volumes.

Consumer control of dispense volume—analogue and or digital output rather than digital.

Internal mechanical energy storage system controls delivery pressure reducing user variability.

Internal mechanical energy storage system creates and/or limits minimum actuation pressure which can be specified and/or selected to reduce/minimise dribbling at the end of the stroke.

Reduced fatigue for same dispense volume.

Potential for more ergonomic design.

Benefits Vs. Liquid Propellant Aerosol Systems

Non-flammable.

Gasless/airless system.

Bulk liquid stored in non-pressurised state.

Only a proportion of the product is stored in a pressurised state.

Pressure significantly less affected by environmental temperatures.

The avoidance of liquid propellant may allow the product to be carried as hand luggage on aircraft.

System accommodates refill/reuse concepts, reducing plastic waste and reduces commercial costs.

Reduced “pressure vessel” specification requirements.

Ability to draw fluids from one or more liquid reservoirs and mix within one or more dosing chambers or mix at the point of dispense.

Zero pressure remaining at end of product dispense providing safer disposal.

Orientation does not affect performance.

Transparent primary and/or dosing chamber allows users to observe the product and to track product fill level and usage.

Smaller pack can be created by the removal of the primary container.

Ability to provide a high-pressure system without having the pack being constantly under pressure.

Reduced restrictions associated with transport and storage.

Avoidance of costly and highly specialist filling and packing equipment.

Benefits Vs. Compressed Gas Aerosol Systems

Gasless/airless system.

Bulk liquid stored in non-pressurised state.

Only a proportion of the product is stored in a pressurised state.

Fluid-based system reduces energy losses and provides for more constant pressure vs. gas-based systems (Direct pressure vs. compressed gas losses).

Constant force delivers more consistent output.

System accommodates refill/reuse concept, reducing plastic waste and reduces commercial costs.

Reduced “pressure vessel” specification requirements.

Zero pressure remaining at end of product dispense.

Ability to draw fluids from one or more liquid reservoirs and mix within one or more dosing chambers or mix at the point of dispense.

Orientation does not affect performance.

Avoids the issues with pressure loss and pressure drop off seen with compressed gas systems.

Transparent primary and/or dosing chambers allows users to observe the product and to track product fill level and usage.

Smaller pack can be created by the removal of the primary container.

Ability to provide a high-pressure system without having the pack being constantly under pressure.

Reduced restrictions associated with transport and storage.

Avoidance of costly and highly specialist filling and packing equipment.

### BRIEF DESCRIPTION OF THE DRAWINGS

FIG. 1 illustrates an example of a spray device embodying the present invention;

FIG. 2 illustrates internal components of the spray device of FIG. 1;

FIGS. 3(a) and (b) illustrate perspective views of an alternative embodiment;

FIGS. 4(a) and (b) illustrate side views of the alternative embodiment;

FIG. 5 illustrates insertion of a fluid reservoir into the alternative embodiment;

FIGS. 6(a), (b) and (c) illustrate close-up views of parts of the alternative embodiment;

FIGS. 7(a) and (b) illustrate a preferred form of plunger; and

FIGS. 8(a), (b) and (c) illustrate embodiments for use with multiple reservoirs.

### DETAILED DESCRIPTION OF THE PREFERRED EMBODIMENTS

The invention will be more clearly understood from the following description, given by way of example only, with reference to the accompanying drawings.

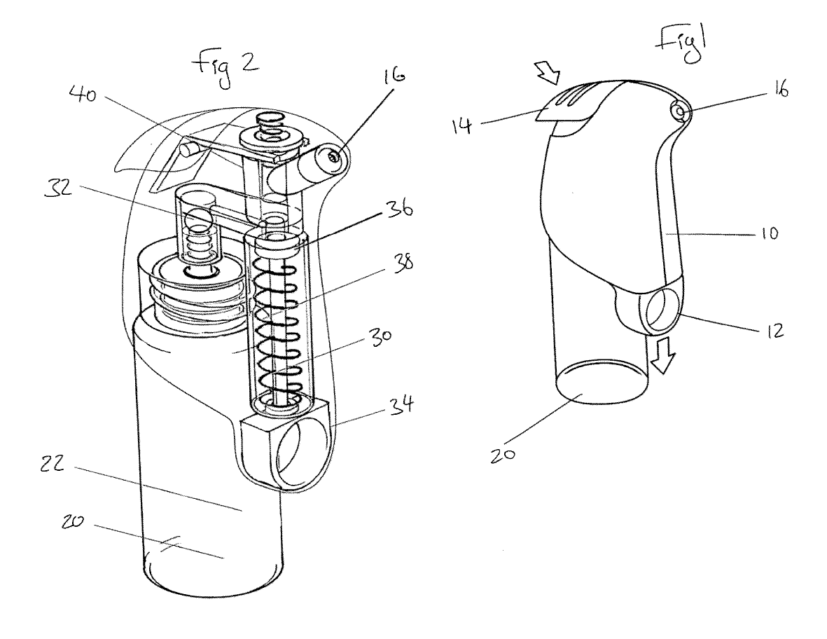

As illustrated in FIG. 1, a spray device 10 may be fitted to a fluid reservoir 20. A tab 12 may be pulled downwardly so as to fill the dosing chamber. A button 14 may be provided for actuation by a user. Actuation of the button 14 releases a valve to cause spray from the nozzle 16.

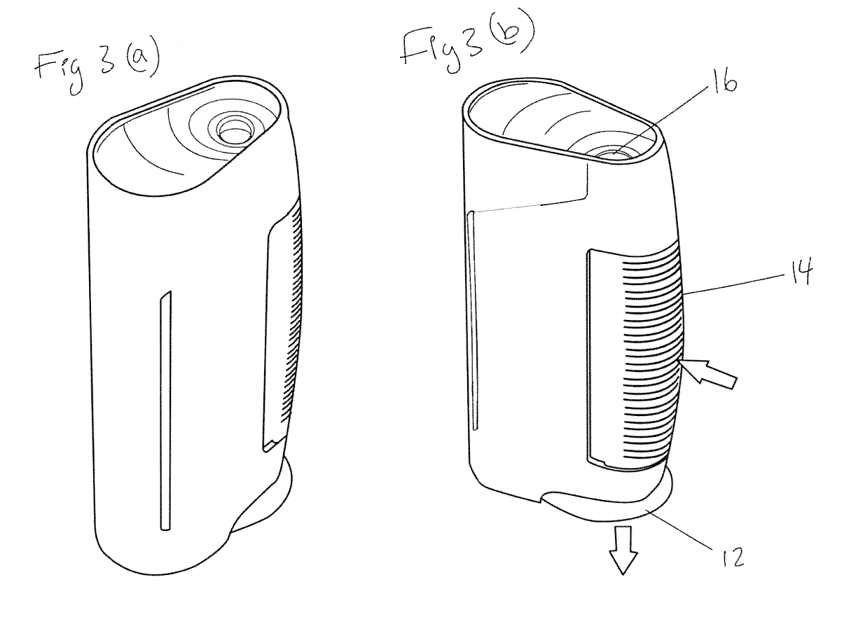

As illustrated in FIG. 2, the spray device includes a dosing chamber 30 which is in fluid communication with the reservoir 20. The reservoir 20 of this embodiment is provided with its own dip tube 22 separate from the spray device 10. In this way, it is possible to freely attach and detach the spray device 10 from the reservoir 20. As illustrated, a thread is provided for this purpose. The dosing chamber 30 is connected to the reservoir 20 using a non-return ball valve 32. The non-returnable ball valve 32 allows fluid to travel from the reservoir 20 (via its dip tube 22) into the spray device 10, but does not allow fluid to flow back from the spray device 10 into the bottle reservoir 20 or, if the spray device 10 has been removed from the reservoir 20, to atmosphere.

As illustrated, the pull tab 12 is formed as part of a plunger 34 which extends into the dosing chamber 30 and has, at its far end, a piston 36. The plunger 34 may be pulled outwardly of the spray device 10 and the dosing chamber 30 against the bias of a compression spring 38. As the piston 36 travels from a first end of the dosing chamber 30 to a second end of the dosing chamber 30, fluid is drawn through the connector and its non-return ball valve 32 into the dosing chamber 30. This fluid is then kept under pressure by means of the compression spring 38.

The spray device 10 includes a dispensing portion having the nozzle 16 and a dispensing valve 40 operable by the button 14. The dispensing valve 40 selectively provides fluid communication between the nozzle 16 and the dosing chamber 30.

In this way, with the dosing chamber 30 primed and holding fluid under compression, whenever a user operates the button 14 to open the valve 40, fluid is ejected from the nozzle 16 under the pressure of the compression spring 38. Sustained ejection of fluid may be achieved for the volume of fluid held in the dosing chamber 30.

In the preferred embodiment, the relative dimensions of the device 10 including the dosing chamber 30 and compression spring 38 are such that, when the piston 36 travels between the first and second ends, the compression spring 38 always operates substantially within its constant spring force region. In this way, spray uniformity and consistency in performance is obtained throughout use of the device 10, in particular throughout travel of the piston 36 for dispensing fluid from the dosing chamber 30 whether the dosing chamber 30 is full or nearly empty.

### How the Illustrative Design Works

The non-pressurised fluid reservoir 20 is attached in a liquid tight manner to the pump 36 and dosing chamber 30 system.

The spring 38 in the dosing chamber 30 is compressed though manual actuation of the plunger 34.

The pressure in the dosing chamber 30 and above the valve 32 that closes of the non-pressurised fluid reservoir 20 falls as a result of increased volume within the dosing chamber 30.

The pressure drop opens the valve 32 which connects to the dip tube 22 whose open end lays below the fluid level of the non-pressurised fluid reservoir 20.

Fluid is drawn up the dip tube 22 past the valve 32 and into the dosing chamber 30 filling its volume with fluid.

A venting mechanism within the fluid reservoir 20 provides for pressure equalisation. (Only necessary for a non-collapsible fluid reservoir design.)

At the end of the actuation stroke or when the force applied to the plunger 34 is removed, a pressure within the dosing chamber 30 as generated by the spring 38. This pressure closes the valve 32 above the dip tube 22.

The fluid within the dosing chamber 30 now experiences the force imposed by the compressed spring 38.

On depressing the spray actuator 14, the outlet valve 40 opens and the fluid is forced under pressure out of the dosing chamber 30 and through the outlet orifice 16.

As the fluid passes through the outlet orifice 16, the spray is broken up by the pressure change experienced at the outlet 16 and the mechanical design features within the fluid path.

Fluid continues to spray from the dosing chamber 30 in a consistent and controlled manner through the outlet orifice 16 until either the container 30 is emptied or the outlet valve 40 is closed as a result of releasing the spray actuator 14.

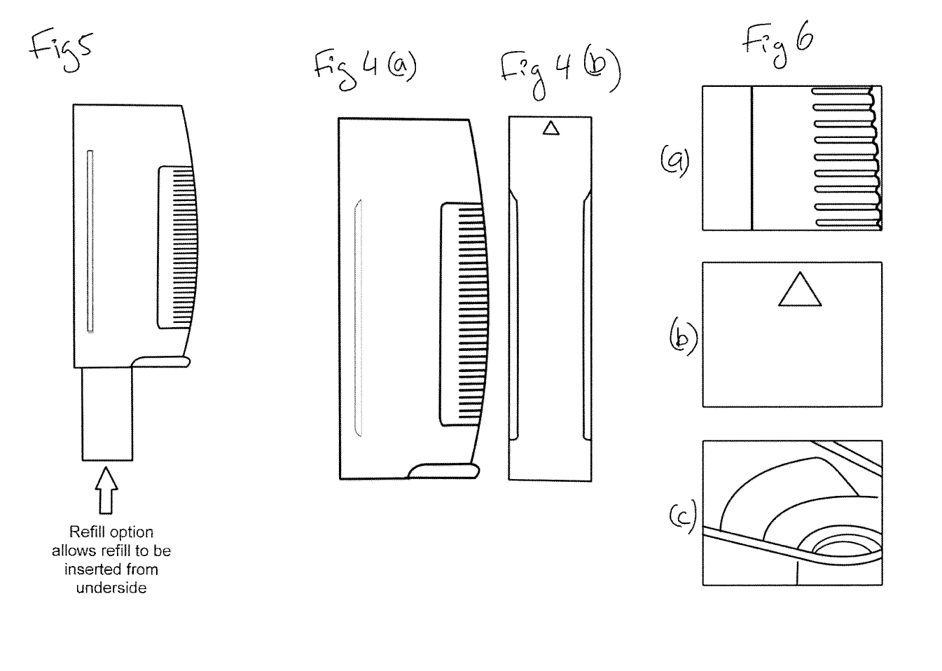

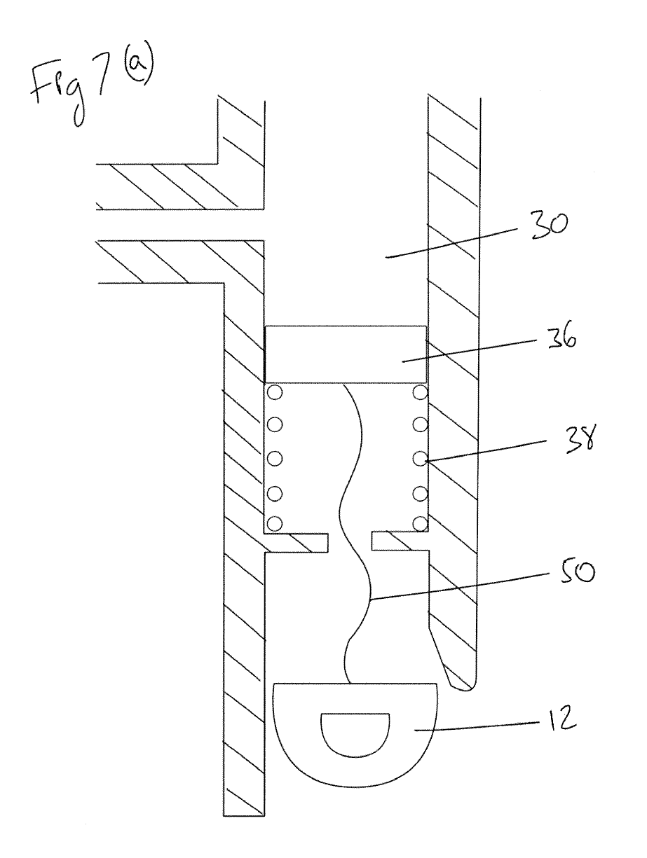

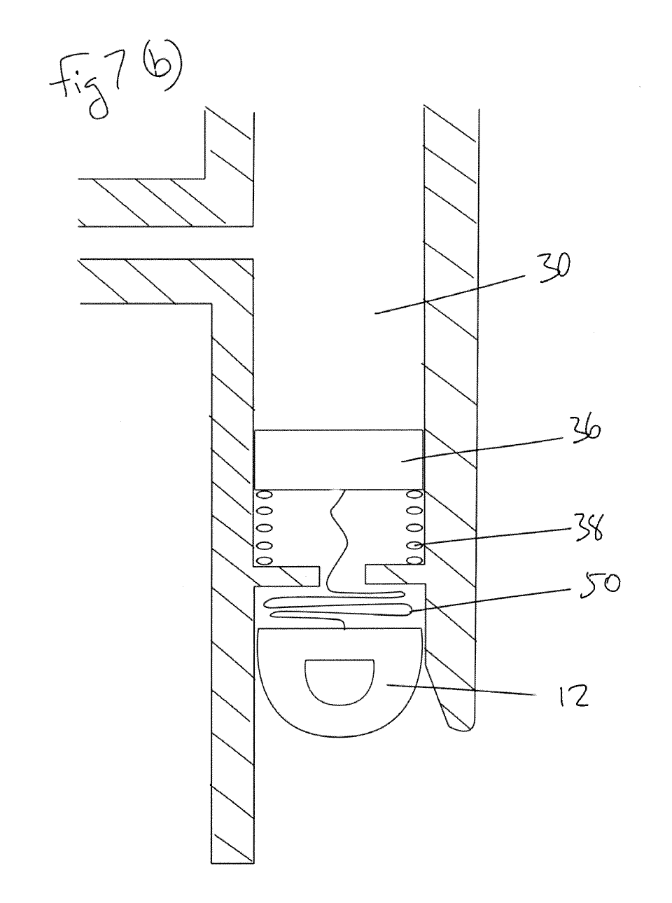

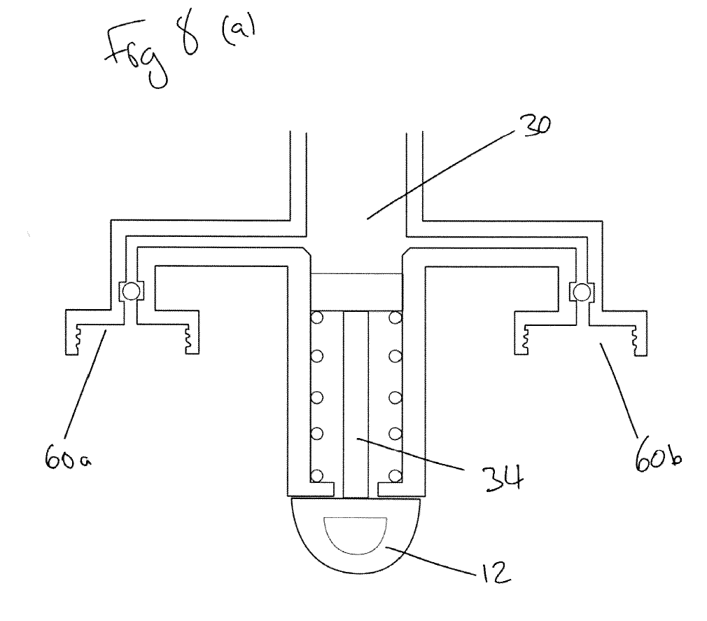

FIGS. 3 to 6 illustrate an alternative embodiment in which a reservoir 20 may be inserted into and housed within the spray device.

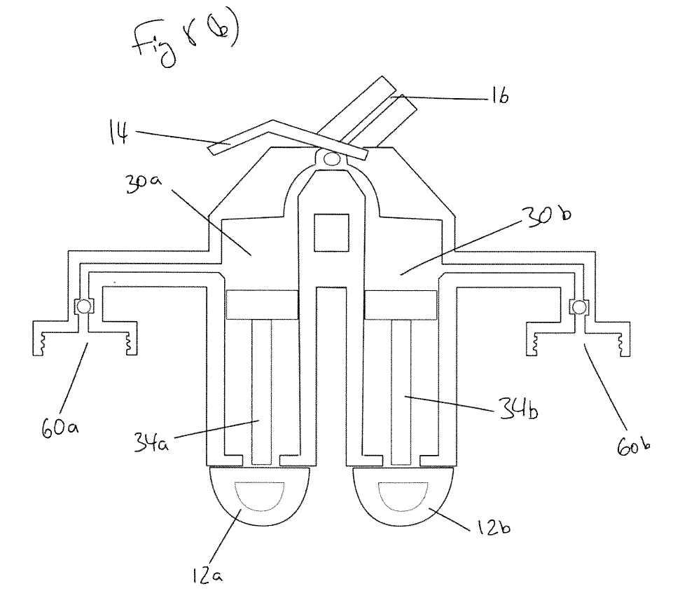

The embodiment described above particularly with reference to FIG. 2 includes a rigid plunger 34. However, it is also possible to use a plunger which includes a flexible member by which a user, by pulling on the tab 12, can pull the piston 36 against the force of compression spring 38. This is illustrated in the partial cross sections of FIGS. 7(a) and (b). In a preferred embodiment, as illustrated in FIGS. 7(a) and (b), the plunger includes a flexible member 50 which itself has a resilient nature. In particular, the flexible member 50 is biased so as to return to a collapsed state, for example in the form of a coil.

As illustrated in FIG. 7(a), a user pulls the tab 12 so as to move the piston 36 within the dosing chamber 30 against the force of the compression spring 38. In particular, the flexible member 50 transfers a tensile load. Then, as illustrated in FIG. 7(b) with fluid in the dosing chamber 30 preventing return movement of the piston 36, it is possible for the flexible member 50 to be collapsed such that the tab 12 can return to its original position for neat storage. It would be possible merely for a user to carefully stow the flexible member 50 as required. Also, it would be possible to provide a mechanism, such as a biased pulley-wheel mechanism, for retracting the flexible member 50. However, according to the preferred embodiment, the flexible member 50 resiliently returns to a coiled arrangement allowing easy and neat return of the tab 12 to its original position as illustrated in FIG. 7(b).

It is possible to provide features in the spray device, particularly a system spring mechanism, that allows for integral fill levels to be drawn into the dosing chamber. By using constant force springs, consistent performance can also be achieved throughout the dispensing range.

It is highly advantageous that the spray device is removable from the reservoir and forms a self-contained pressurised container. It is preferable, therefore, that the connection with the reservoir does not require any components of the spray device to be inserted into the fluid of the reservoir.

The nozzle may be arranged to be self-adjusting so as to accommodate variable viscosities under the same spring force. Also, a rapid spray shut-off mechanism may be provided to improve spray consistency and to prevent dribbling.

A mesh may be provided at the outlet of the nozzle orifice so as to provide foaming where necessary. This is particularly advantageous with the spring-pressurised system of the present invention, because of the resulting constant force provided by the spring.

Similarly, there is the option of providing a venturi to enable air to be bled into the product stream so as to create a desired foam or improve atomisation. Once again, the constant spring drive force supports the generation of an improved foam consistency.

Other embodiments are possible where multiple reservoirs are provided. This has the advantage of an improved shelf life for non-compatible liquids. It also gives the possibility of user selection. A common base formulation may be provided and the user may have the ability to add (and mix during drawing liquid into the dosing chamber) a number of alternative secondary liquids, for instance fragrance options. It is also possible for separate dosing chambers to be provided and the mixing to occur at the time of dispensing/spraying.

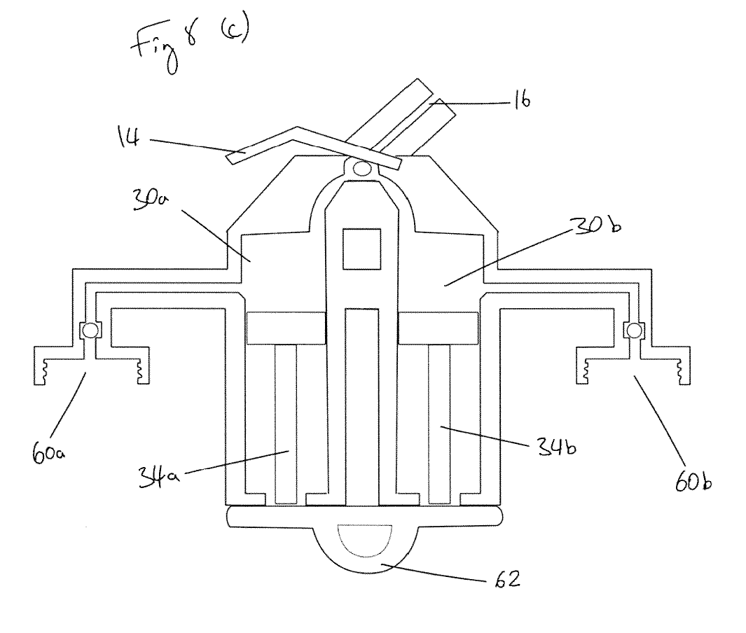

FIGS. 8(a), (b) and (c) illustrate schematically three alternative embodiments for use with multiple reservoirs.

As illustrated in FIG. 8(a), a first connector 60a is provided for connection with a first reservoir and a second connector 60b is provided for connection with a second reservoir. Respective one-way valves may be provided in the connectors 60a, 60b so as to allow only one-way flow of fluid from a reservoir. Both connectors communicate with the dosing chamber 30. When the tab 12 is used to operate the plunger 34, fluid can thus be drawn from both reservoirs simultaneously into the dosing chamber 30 for subsequent dispensing through a common nozzle. The relative mix of fluids from respective reservoirs can be controlled, for example, by the relative diameters of passages feeding the dosing chamber 30.

In the embodiment of FIG. 8(b) separate respective dosing chambers 30a and 30b are provided for receiving fluid from respective connectors 60a and 60b. In this way, it is possible to keep the respective fluids isolated from one another until they are actually dispensed by the nozzle. As illustrated schematically, the two dosing chambers 30a, 30b are selectively connected to a common nozzle 16 according to operation of a common button 14. The common button 14 can operate separate respective valves each for connecting respectively a dosing chamber to the nozzle 16. Alternatively, it may be possible to have both dosing chambers 30a, 30b connected to a single valve connecting them to the nozzle 16.

In this illustrated embodiment, respective tabs 12a and 12b are provided for operating the respective plungers 34a, 34b of the respective dosing chambers 30a, 30b. However, as illustrated in FIG. 8(c), it is also possible to arrange for a single tab 62 to operate both plungers 34a and 34b simultaneously.

Relative proportions of fluid from different reservoirs can be determined, for example, by the diameters of the respective dosing chambers 30a and 30b. Also, relative dispensing can be controlled by virtue of passageway sizes feeding the nozzle 16 and also relative compression forces of the respective compression springs.

It will be appreciated that the same techniques can be applied to devices having three or more connectors for connection with three or more reservoirs. Also, the illustrated plungers can be replaced by flexible members such as described with reference to FIGS. 7(a) and (b).

We claim:

1. A spray device for connection to a reservoir of fluid for spraying, the spray device including:
a dosing chamber for holding fluid;
a connector for fluidly connecting the dosing chamber to the reservoir;
a piston moveable from a first end of the dosing chamber to a second end of the dosing chamber so as to draw into the dosing chamber fluid from the reservoir;
a spring biasing the piston towards said first end;
a plunger, actuable by a user, to move the piston towards said second end against the bias of the spring;
a nozzle for spraying fluid; and
a user-actuable valve for selectively fluidly connecting the dosing chamber to the nozzle.

2. A spray device according to claim 1 further including:
an additional connector for fluid connection to an additional reservoir such that the nozzle can simultaneously spray fluid supplied from respective reservoirs.

3. A spray device according to claim 2 wherein said connector and said additional connector are connected to said dosing chamber such that movement of said piston from the first end of the dosing chamber to the second end of the dosing chamber draws into the dosing chamber fluid from said reservoir and said additional reservoir.

4. A spray device according to claim 2 further including:
an additional dosing chamber wherein said additional connector is configured to fluidly connect said additional dosing chamber to said additional reservoir; and
an additional piston moveable from a first end of the additional dosing chamber to a second end of the additional dosing chamber so as to draw into the additional dosing chamber fluid from the reservoir; wherein
the user actuable valve is configured to selectively fluidly connect the additional dosing chamber to the nozzle simultaneously with fluidly connecting said dosing chamber to the nozzle.

5. A spray device according to claim 4 wherein said plunger is configured to move said additional piston towards said second end of said additional dosing chamber simultaneously with moving said piston towards said second end of said dosing chamber.

6. A spray device according to claim 4 further including:
an additional plunger actuable by a user, to move said additional piston towards said second end of said additional dosing chamber.

7. A spray device according to claim 1 further including:
a valve configured to allow only one-way flow of fluid from a reservoir to the spray device.

8. A spray device according to claim 1 wherein said plunger includes a flexible member connecting said piston to a user actuable tab.

9. A spray device according to claim 8 wherein said flexible member is a resilient coil configured to collapse to a coiled configuration after said piston is moved towards said second end of said dosing chamber.

10. A spray device according to claim 1 in combination with a reservoir for containing a fluid for spraying wherein:
the reservoir is configured to be connected to said connector.

11. A spray device according to claim 10 wherein said reservoir includes a means of venting to avoid the creation of vacuum as fluid is drawn via the connector to the dosing chamber.

12. A spray device according to claim 10 wherein said reservoir comprises a collapsible bag.

13. A spray device according to claim 1 wherein the connector is configured to detachably attach to the reservoir.

14. A method of spraying fluid including:
using a user-actuable plunger to move a piston in a dosing chamber to draw fluid from a reservoir into the dosing chamber against the bias of a spring acting on the piston; and
selectively connecting the dosing chamber to a nozzle so as to allow fluid to be expelled from the dosing chamber under the bias of the spring and through the nozzle.
